(19) United States
(12) Patent Application Publication
(10) Pub. No.: US 2020/0331944 A1
(43) Pub. Date: Oct. 22, 2020

(54) COMPOUND

(71) Applicant: GAS-PHASE GROWTH LTD., Koganei-shi (JP)

(72) Inventors: Hideaki MACHIDA, Koganei-shi (JP); Masato ISHIKAWA, Koganei-shi (JP); Hiroshi SUDOH, Koganei-shi (JP)

(73) Assignee: GAS-PHASE GROWTH LTD., Koganei-shi (JP)

(21) Appl. No.: 16/833,827

(22) Filed: Mar. 30, 2020

(30) Foreign Application Priority Data
Apr. 22, 2019 (JP) 2019-081378

(51) Int. Cl. C07F 15/06

(52) U.S. Cl. CPC C07F 15/065

(57) ABSTRACT

A purpose of the invention is to provide a novel compound.

The novel compound is represented by M[i-C₃H₇NC(R)N-i-C₃H₇]₂ (where, M=Co or Fe; R=n-C₃H₇ or i-C₃H₇) that is a liquid under 25° C. (at 1 atmospheric pressure).

### TECHNICAL FIELD

The present invention relates to a novel compound.

### BACKGROUND ART

Co (metallic cobalt (e.g., film)) is demanded in the semiconductor field. The Co has a low electric resistance. Therefore, it is largely expected to be used as a diffusion prevention film for copper wiring of a semiconductor circuit. It is largely expected to be used as a liner for copper wiring of a semiconductor circuit. Further, studying has been conducted in employing the Co for preparing a wiring itself of a semiconductor circuit.

The Co and Fe (metallic iron (e.g., film)) are magnetic materials. For this characteristic, they are demanded in the field of MEMS (Micro Electro Mechanical Systems). The Co and the Fe are essential materials, for example, for the next-generation memories (e.g., MRAM).

A FeSi₂ alloy film has an extremely high light absorption coefficient (about hundredfold of single-crystal Si). This enables to provide a thin film when the FeSi₂ alloy is applied to solar batteries. It is said that the FeSi₂ alloy film has a theoretical photoelectric conversion efficiency of 16-23%. Therefore, the FeSi₂ alloy commands attraction as a material for providing thin film solar batteries.

By the Chemical Vapor Deposition method (CVD method) or the Atomic Layer Deposition method (ALD method), a Co/Fe based film (e.g., Co film, cobalt oxide film, Fe film, iron oxide film) is deposited. In this case, for example, the followings are proposed as a raw material: β-diketonato cobalt complex, β-diketonato iron complex, cyclopentadienyl based cobalt complex, and cyclopentadienyl based iron complex.

In a case where β-diketonato complex (the compound has 0 (oxygen atom)) is used as a raw material compound, 0 enters the inside of a deposited film. For this reason, in a case where a film is a cobalt oxide film or an iron oxide film, it is considered that no serious problem occurs. To the contrary, in a case where a targeted film is a film which originally does not have oxygen (0), a problem may occur.

A cyclopentadienyl based complex (e.g., bis(cyclopentadienyl)cobalt; Cp₂Co) does not have 0 (oxygen atom). Therefore, when the complex is used, basically, it is considered that 0 does not enter the inside of the film. To the contrary, a cyclopentadienyl based cobalt complex has a high decomposition temperature. This raises a concern that C (carbon atom) may enter the inside of the film. The same may occur when a bis(cyclopentadienyl)iron (Cp₂Fe) is used as a raw material.

As the Co complex (having no 0 (oxygen atom)) and the Fe complex (having no 0 (oxygen atom)), (N, N′-diisopropylpropionamidinate) cobalt {Co[i-C₃H₇NC(C₂H₅)N-i-C₃H₇]₂} is proposed. (N, N′-diisopropylpropionamidinate) iron {Fe[i-C₃H₇NC(C₂H₅)N-i-C₃H₇]₂} is proposed. When film deposition is performed with the above proposed complexes by the CVD method (or the ALD method), a Co film and a Fe film having a high purity are provided. The Co[i-C₃H₇NC(C₂H₅)N-i-C₃H₇]₂} is a solid (having a melting point of about 38° C.). The Fe[i-C₃H₇NC(C₂H₅)N-i-C₃H₇]₂ is a solid (having a melting point of about 33° C.). When the compounds that are solid at room temperature are heated to melt, the vapor resulted therefrom is transported to a film deposition reaction chamber. At the time, a pipe (pipe for transporting vapor) needs to be heated. If the pipe is not heated, the compound is solidified to be deposited inside the pipe. The pipe results in being clogged. In a case of the melting point (i.e., 33° C., 38° C.) as mentioned above, the problem can be controlled in depositing a film at laboratory level (small scale). The problem, however, will become more serious at mass production level in a factory. For example, if only there is a cool part in the pipe, solidification and deposition will occur inside the pipe at the part to cause the clogging of the pipe. This will stop the manufacturing line. Because a series of processes is performed at the mass production level, many wafers will be wasted. The damage becomes larger. In the recent semiconductor mass production factory, a large quantity of raw material compound is transported into the reaction chamber. The so-called Direct Liquid Injection System is employed. According to the method, the raw material is directly transported into a vaporization chamber in the form of a liquid. The compound (gas) vaporized in the vaporization chamber is transported to the film deposition reaction chamber. In this case, as a matter of fact, the compound needs to be a liquid at room temperature. In a case where the compound is a solid (melting point (38° C., 33° C.)), the compound becomes a liquid when heating. It, however, requires heat energy. Solidification of inside the pipe which causes clogging of the pipe is also concerned.

Further, compound having a high purity is demanded for semiconductor factories. For obtaining the highly purified compound, distillation is a necessary step. In a case of distilling a solid compound at room temperature, gas is solidified in a cooling part (condenser). This makes a distillation operation troublesome. By setting a cooling temperature at or higher than the melting point, the solidification can be avoided. This, however, invites difficulty in controlling the temperature. This also invites loss of heat energy.

### REFERENCES

### Patent Documents

[Patent Document 1] WO 2013/051670A1

[Patent Document 2] JP 2016-172894A1

[Patent Document 3] WO 2004/046417A1

[Patent Document 4] JP 2011-63848A1

[Non-Patent Document 1] Zhengwen Li, Don Kuen Lee, Michael Coulter, Leonard N. J. Rodriguez and Roy G. Gordon, Dalton Trans., 2008, 2592-2597

### DISCLOSURE OF THE INVENTION

### Problem To Be Solved By The Invention

As described in the above BACKGROUND OF THE INVENTION, there is a demand for a metal complex (the metal M=Co, Fe) in the form of a liquid (being liquid under 25° C. (1 atmospheric pressure)) that can be distilled. At present, a metal complex (the metal M=Co, Fe), that is a liquid (under 25° C. (1 atmospheric pressure)) capable of being distilled to obtain the metal M (M=Co, Fe) and that has no isomer, is not proposed.

In view of the above, a purpose of the invention is to solve the above described problems. For example, the purpose of the invention is to provide a technique that can provide M (M=Co, Fe) material (e.g., film) of high quality with ease. For example, the purpose of the invention is to provide a Co complex that is a liquid (being liquid under 25° C. (1 atmospheric pressure)) and has no isomer. For example, the purpose of the invention is to provide a Fe complex that is a liquid (being liquid under 25° C. (1 atmospheric pressure)) and has no isomer.

### Means for Solving the Problems

Intensive studies for solving the above problems have been keenly conducted.

As a result, it was known that Co[i-C₃H₇NC(i-C₃H₇)N-i-C₃H₇]₂, Co[i-C₃H₇NC(i-C₃H₇)N-i-C₃H₇]₂, and Fe[i-C₃H₇NC(n-C₃H₇)N-i-C₂ H₇)₂ are liquids (being liquid under 25° C. (1 atmospheric pressure)). A highly purified product of the compound could be obtained by a distillation operation thereof. It can be understood that a film of high quality can be obtained by the CVD method (or the ALD method), if the compound is employed.

The present invention was achieved based on the above described information.

The present invention proposes:

a compound represented by M[i-C₃H₇NC(R)N-i-C₃H₇]₂ (where M=Co or Fe; R is n-C₃H₇ or i-C₃H₇) that is a liquid under 25° C. (1 atmospheric pressure).

The present invention proposes:

a compound that is used in a method in which the compound is transported to a chamber and the compound transported to the chamber is decomposed to deposit a M based material on a substrate,

wherein the compound

is represented by M[i-C₃H₇NC (R)N-i-C₃H₇]₂ (where M=Co or Fe ; R i s n-C₃H₇ or i -C₃H₇) , and

is a liquid under 25° C. (1 atmospheric pressure).

For example, the present invention proposes Co[i-C₃H₇NC(n-C₃H₇)N-i-C₃H₇]₂ that is a liquid under 25° C. (1 atmospheric pressure).

For example, the present invention proposes Co[i-C₃H₇NC(i-C₃H₇)N-i-C₃H₇]₂ that is a liquid under 25° C. (1 atmospheric pressure).

For example, the present invention proposes Fe[i-C₃H₇NC(n-C₃H₇)N-i-C₃H₇]₂ that is a liquid under 25° C. (1 atmospheric pressure).

The compound is a novel compound.

The compound has no structural isomer.

A functional group of the compound has no asymmetric carbon atom.

The compound has no optical isomer.

The compound has a vapor pressure (100° C.) of not less than 0.35 Torr.

The present invention proposes:

a material for depositing a M (one or two selected from a group consisting of M=Co, Fe) based material,

wherein the deposition material has a compound represented by M[i-C₃H₇NC(R) N-i-C₃H₇]₂ (where M=Co or Fe; R is n-C₃H₇ or i-C₃H₇).

The present invention proposes:

a method for depositing a M (one or two selected from a group consisting of M=Co, Fe) based material,

wherein a compound represented by M [i-C₃H₇NC(R)N-i-C₃H₇]₂ (where M=Co or Fe; R is n-C₃H₇ or i-C₃H₇) is transported to a chamber and the compound transported to the chamber is decomposed to deposit the M based material on a substrate.

### Effect of the Invention

The compound is a liquid (being liquid under 25° C. (1 atmospheric pressure)).

Because the compound is a liquid, a highly purified product could be obtained by an easy distillation operation.

The compound is liable to vaporize (i.e., has a high vapor pressure). The compound can be transported stably when the compound is in a gas state. Therefore, a material (e.g., film) of high quality could be obtained at low cost by the CVD method (or the ALD method). Film-deposition efficiency is high. For example, a M (M=Co, Fe) metal film of high quality could be deposited efficiently. Alternatively, a M (M=Co, Fe) alloy film could be deposited efficiently.

The compound has no 0 (oxygen atom). As a result, the deposited film does not (substantially) include 0. Even if 0 would be included in the deposited film, a content of 0 is small.

### BRIEF DESCRIPTION OF DRAWINGS

FIG. 1 is a schematic diagram of a CVD apparatus.

FIG. 2 is another schematic diagram of the CVD apparatus.

FIG. 3 is a graph representing vapor pressures.

### BEST MODE FOR CARRYING OUT THE INVENTION

The first invention is a novel compound. The compound is M[i-C₃H₇NC(R) N-i-C₃H₇]₂ (where M=Co or Fe; R is n-C₃H₇ or i-C₃H₇). The compound is represented by the following [Chemical Formula 1], [Chemical Formula 2], and [Chemical Formula 3]. For example, the compound is Co[i-C₃H₇NC(n-C₃H₇)N-i-C₃H₇]₂ (bis(N, N′-diisopropylbutaneamidinate) cobalt). For example, the compound is Co[i-C₃H₇NC(i-C₃H₇)N-i-C₃H₇]₂ (bis (N, N′-diisopropyl-2methylpropionamidinate) cobalt). For example, the compound is Fe[i-C₃H₇NC(n-C₃H₇)N-i-C₃H₇]₂ (bis(N, N′-diisopropylbutaneamidinate) iron. The compound (complex) is a liquid (being liquid under 25° C. (1 atmospheric pressure)). Therefore, the distillation operation made it possible to obtain a highly purified product of the compound with ease. The compound has no structural isomer. A functional group of the compound does not have an asymmetric carbon atom. The compound has no optical isomer. The reason why the nonexistence of isomer is important is set forth below. Miniaturization and complication progress in the recent semiconductor field. For example, there is a case where film deposition is provided to a fine hole or groove (An opening portion thereof has a width of several ten nm and a depth of 10-200 folds of the opening portion, further, more than 200 folds of the opening portion). For achieving such film deposition, it is said that the ALD method is essential. In such case, it is necessary that a raw material molecule for depositing a film should chemically absorb to a finish end of a base (e.g., OH base, —NH₂ base). For achieving the chemical adsorption, it is preferred that an orientation and an arrangement of the raw material molecules are well ordered. In a case where the raw material molecules were arranged asymmetrically, it was difficult to achieve the chemical adsorption of the well-ordered arrangement. In a case where the raw material molecules were optically active (optical isomer), it was difficult to achieve the chemical adsorption of the well-ordered arrangement. A film deposited in this state is deteriorated in density and thus has a high resistivity. Therefore, absence of an isomer is preferred. In the absence of an isomer, purification is easy. A compound disclosed in the below mentioned Reference Example includes an isomer. For this reason, it was not preferred as the film deposition material. Isolation (separation, purification) is extremely difficult (impossible at present). The compound of the present invention has a high vapor pressure. For example, the compound has the vapor pressure (100° C.) of 0.35 Torr or more, further, 0.4 Torr or more, still further, 0.47-0.55 Torr. The vapor pressure (100° C.) of Co-[i-C₃H₇NC(n-C₃H₇)N-i-C₃H₇]₂ was 0.53 Torr. The vapor pressure (100° C.) of Co[i-C₃H₇NC(i-C₃H₇)N-i-C₃H₇]₂ was 0.47 Torr. The vapor pressure (100° C.) of Fe[i-C₃H₇NC(n-C₃H₇)N-i-C₃H₇]₂ was 0.55 Torr. The gas saturation method was employed for measuring the vapor pressure. The film deposition by the CVD method or the ALD method was easy.

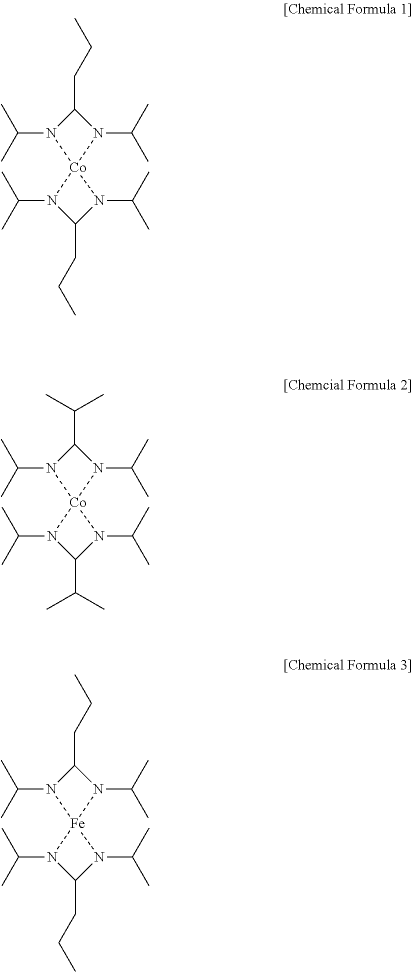

The second invention is a deposition material. The material is a material for depositing M (where one or two selected from a group consisting of M=Co, Fe) based material. The M based material is, for example, a Co based film. For example, it is a Co metal film. For example, it is a Co alloy film. For example, it is a CoX (where X is a nonmetallic element (e.g., N, B, etc. (more specifically, elements other than 0)) or a semiconductor element) film. For example, it is a Fe based film. For example, it is a Fe metal film. For example, it is a FeCo based alloy film. For example, it is a Fe alloy film. For example, it is a FeX (where X is a nonmetallic element (e. g. , N, B, etc. (more specifically, elements other than 0)) or a semiconductor element) film. For example, it is a FeCoX (where X is a nonmetallic element (e.g., N, B, etc. (more specifically, elements other than 0)) or a semiconductor element) film. The material is not limited to a film. The one that is thicker than a concept of film may be acceptable. The material has the compound (complex: one or two, or more selected from the group consisting of Co[i-C₃H₇NC(n-C₃H₇) N-i-C₃H₇]₂, Co[i-C₃H₇NC (i-C₃H₇]₂, and Fe[i-C₃H₇NC(n-C₃H₇) N-i-C₃H₇]₂) . The material is, for example, the compound that is dissolved in a solvent. In a case where the compound was used, a film of high quality could be obtained efficiently by the CVD method (or the ALD method).

The third invention is a method. The method is a deposition method. According to the method, the compound (complex: one or two, or more selected from the group consisting of Co[i-C₃H₇NC(n-C₃H₇)N-i-C₃H₇]₂, Co[i-C₃H₇NC(i-C₃H₇)N-i-C₃H₇]₂, and Fe[i-C₃H₇NC(n-C₃H₇)N-i-C₃H₇]₂) is transported to a chamber and the transported compound (complex) is decomposed to provide the M based material on a substrate. The method includes a step of transporting the compound (complex) to the chamber. The method includes a step of providing the M based material on a substrate by means of the decomposition of the compound (complex) transported to the chamber. As the method, for example, the CVD method is employed. For example, the ALD method is employed. The chamber is, for example, a film deposition chamber (also referred to as a decomposition chamber or a reaction chamber).

The M based material (e.g., a film) obtained in a manner as described above contained extremely small amount of 0 and/or C (impurities). In other words, the M based material had a high purity.

In the film deposition process, a hindrance hardly occurred. For example, the film deposition was performed by vaporization and decomposition of the compound (raw material (x (g)). After the raw material of 0.733 (g) was consumed, the film deposition operation was stopped. An observation of the inside of a pipe that connects between a raw material container and the film deposition chamber was made. There was no clogging (clogging caused by solidification of the raw material) inside the pipe.

Hereinafter, specific Examples will be described. The present invention, however, should not be construed as being limited to the following Examples. Unless various changes and modifications otherwise depart from the spirit and scope of the present invention, they should be construed as being included in the invention.

### EXAMPLE 1

{Co[i-C₃H₇NC(n-C₃H₇)N-i-C₃H₇]₂: the [Chemical Formula 1]}

The reaction was performed under an inert gas atmosphere. N, N′-diisopropylcarbodiimide of 0.285 mol was slowly dropped into a diethyl ether solution of 280 ml, the diethyl ether solution containing normal propyl lithium of 0.284 mol, followed by stirring thereof at room temperature for 4 hours. The mixed reaction liquid was gradually dropped into a solution in which cobalt chloride (CoCl₂) of 0.142 mol was suspended in tetrahydrofuran of 100 ml, followed by stirring thereof for 24 hours. After distillation of the solvent, normal hexane of 500 ml was added thereto, followed by filtration of insoluble matters. After distillation of the solvent, distillation was performed under reduced pressure (0.1 torr). The compound [Chemical Formula 1] could be obtained by yield of 89%.

Thus obtained compound [Chemical Formula 1] of 300 g was subjected to distillation and purification under reduced pressure. The vapored compound [Chemical Formula 1] (vapor) was liquified while passing through an air cooled tube to be collected in a receiving container. At the time, the air cooled tube was left at room temperature for cooling without being subjected to any cooling or heating operation. The compound could be obtained by yield of 98%.

The refined product (the compound [Chemical Formula 1]) was crystalized by cooling. The crystalized compound [Chemical Formula 1] was gradually heated. It melted at 15-16° C. The compound [Chemical Formula 1] was a liquid (under the condition of 25° C. (1 atmospheric pressure)). When it was subjected to distillation under reduced pressure by using an oil rotation type vacuum pump, a boiling point thereof was 102° C.

The refined product had a high purity. An analysis value (unit: wt. ppm) obtained by the Inductively Coupled Plasma Mass Spectrometry (ICPMS) was as follows. Na<0.1, Mg<0.1, Fe=0.4, Zn=0.3, Ti<0.1, Cu=0.1, Cd<0.1, Mn<0.1, Ni=1.1, and Pb<0.1.

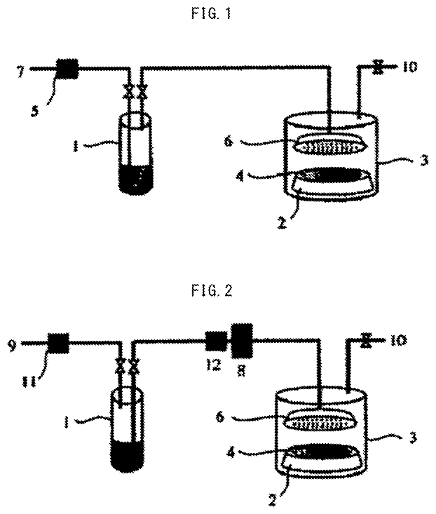

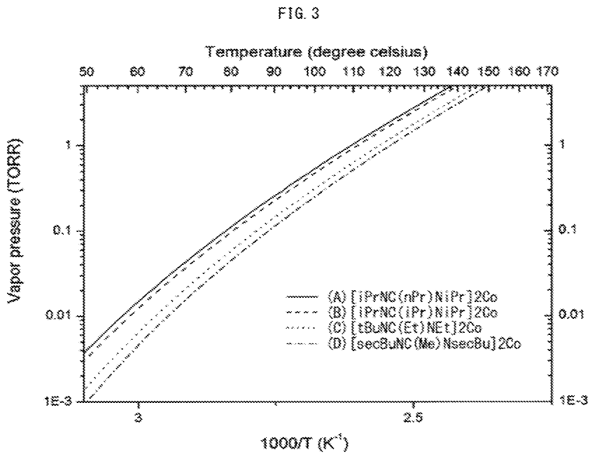

A film deposition operation was conducted by using a film deposition apparatus of FIG. 1. FIG. 1 is a schematic diagram of the film deposition apparatus. In FIG. 1, 1 denotes a raw material container. 2 denotes a substrate heater (which holds and heats a substrate). 3 denotes a film deposition chamber (decomposition reaction furnace). 4 denotes a substrate. 5 denotes a flow controller. 6 denotes a shower head. 7 denotes a carrier gas (inert gas such as Ar or N₂) 10 denotes an additive gas (e.g., an inert gas such as Ar and N₂ and a reducing gas such as H₂ and NH₃) that is to be introduced into the film deposition chamber 3 upon deposition of a film.

The refined product (the compound [Chemical Formula 1]) was placed in the raw material container 1. A heater (not shown) attached to the raw material container 1 heated the raw material container 1 to 90° C. The nitrogen gas (carrier gas) was supplied at a rate of 20 ml/min. for bubbling. As a result, the compound [Chemical Formula 1] was introduced into the film deposition chamber 3 together with the nitrogen gas. A predetermined amount of additive gas (Ar gas of 40 sccm, NH₃ gas of 20 sccm, H₂ gas of 80 sccm) 10 was supplied to the film deposition chamber 3. The wall of the film deposition chamber 3, the shower head 6, and a pipe connecting from the raw material container 1 to the shower head 6 are heated (100° C.). A pump (not shown) exhausted to vacuum the inside of the film deposition chamber 3. A pressure control valve (not shown) provided between the film deposition chamber 3 and the pump controls the inside of the film deposition chamber 3 to a desired pressure (e.g., 1 kPa). The substrate heater 2 makes the substrate 4 heated (280° C.). A film (metal thin film containing Co) was deposited on the substrate 4 in 10 min.

Thus deposited film had an excellent in-plane uniformity. The film was checked by the XPS. An amount of C in the film was 4 at % or less. An amount of 0 in the film was 1 at % or less. An amount of N in the film was 0.4 at % or less. The resistivity of the film was 19 μΩcm.

The apparatus of FIG. 1 was used to perform a film deposition operation. The refined product (the compound [Chemical Formula 1]) was placed in the raw material container 1. The heater attached to the raw material container 1 heated the raw material container 1 to 90° C. A nitrogen gas (carrier gas) was supplied at a rate of 20 ml/min. for bubbling. Accordingly, the compound [Chemical Formula 1] was introduced into the film deposition chamber 3 together with the nitrogen gas for 5 seconds. The pump exhausted the inside of the film deposition chamber 3 for 12 seconds. A predetermined amount of additive gas (Ar gas of 40 sccm, NH₃ gas of 20 sccm, and H₂ gas of 80 sccm) 10 was supplied to the film deposition chamber 3 for 5 seconds. The pump exhausted the inside of the film deposition chamber 3 for 12 seconds. Again, the compound [Chemical Formula 1] was introduced into the film deposition chamber 3 together with the nitrogen gas for 5 seconds. The above described process was repeated for 100 times. The wall of the film deposition chamber 3, the shower head 6, and the pipe connecting from the raw material container 1 to the shower head 6 are heated (100° C.). The substrate heater 2 makes the substrate 4 heated (150-200° C.). A film (metal thin film containing Co) was deposited on the substrate 4.

Thus deposited film was uniformly provided on the inside wall of a hole (opening portion having a width of 100 nm and depth of 1 μm). The film had an excellent step covering property. The film was checked by the XPS. An amount of C in the film was 2 at % or less. An amount of 0 in the film was 1 at % or less. An amount of N in the film was 0.2 at % or less. The resistivity of the film in a flat section was 20 μΩcm.

A film deposition apparatus of FIG. 2 was used to perform a film deposition operation. FIG. 2 is a schematic diagram of the film deposition apparatus. In FIG. 2, 1 denotes a raw material container. 2 denotes a substrate heater. 3 denotes a film deposition chamber (decomposition reaction furnace). 4 denotes a substrate. 5 denotes a flow controller. 6 denotes a shower head. 8 denotes a vaporizer. 9 denotes a raw material force feeding gas (e.g., inert gas such as He and Ar. The gas force feeds a raw material from the raw material container 1 to the vaporizer 8). 10 denotes an additive gas (e.g., inert gas such as Ar and N₂ and reducing gas such as H₂ and NH₃) that is to be introduced into the film deposition chamber 3 upon deposition of a film. 11 denotes a pressure controller for controlling the pressure of the raw material force feeding gas 9. 12 denotes a liquid flow controller (for controlling force feeding flow amount of the raw material liquid to the vaporizer 8).

The apparatus of FIG. 2 was used to perform the film deposition operation. The refined product (the compound [Chemical Formula 1]) was placed in the raw material container 1. An N₂ gas was used as the raw material force feeding gas 9. The pressure controller 11 controls the pressure to 0.1 MPa. The liquid flow controller 12 force feeds (A force feeding amount was controlled to 0.1 mg/min.) the compound [Chemical Formula 1]. The compound [Chemical Formula 1] was fed into the vaporizer 8. The pipe through which the compound [Chemical formula 1] passes is left at room temperature. The compound [Chemical Formula 1] that was force fed into the vaporizer 8 was introduced into the film deposition chamber 3 together with the Ar gas (carrier gas) of 50 sccm. A predetermined amount of additive gas (Ar gas of 40 sccm, NH₃ gas of 20 sccm, and H₂ gas of 80 sccm) 10 was also supplied to the film deposition chamber 3. The wall of the film deposition chamber 3, the shower head 6, and a pipe connecting from the raw material container 1 to the shower head 6 are heated (100° C.). A pump (not shown) exhausted to vacuum the inside of the film deposition chamber 3. A pressure control valve (not shown but placed between the film deposition chamber 3 and the pump) controls to keep the desired pressure (e.g., 1 kPa). The substrate 4 is heated (290° C.) by the substrate heater 2. A film (metal thin film containing Co) was deposited on the substrate 4.

Thus deposited film had an excellent in-plane uniformity. The film was checked by the XPS. An amount of C in the film was 3 at % or less. An amount of 0 in the film was 1 at % or less. An amount of N in the film was 0.4 at % or less. The resistivity of the film was 19 μΩcm.

### EXAMPLE 2

{Co[i-C₃H₇NC(i-C₃H₇)N-i-C₃H₇]₂: the Compound [Chemical Formula 2]}

The reaction was conducted under an inert gas atmosphere. N, N′-diisopropylcarbodiimide of 0.21 mol was slowly dropped into a pentane solution of 300 ml, the solution containing isopropyllithium of 0.21 mol, followed by stirring thereof at room temperature for 4 hours. The mixed reaction liquid was gradually dropped into a solution in which cobalt chloride (CoCl₂) of 0.1 mol was suspended in tetrahydrofuran of 200 ml, followed by stirring thereof for 24 hours. After distillation of the solvent, a normal hexane of 500 ml was added thereto. Insoluble matters were filtrated. After distillation of the solvent, distillation was performed under reduced pressure (0.1 torr). The compound [Chemical Formula 2] could be obtained by yield of 70%.

Thus obtained compound [Chemical Formula 2] of 300 g was subjected to distillation under reduced pressure for purification. The volatilized compound [Chemical Formula 2] was liquified while passing through an air cooled tube to be collected in a receiving container. At the time, the air cooled tube was left at room temperature without being subjected to any cooling or heating operation. The compound was collected by yield of 95%.

The refined product (the compound [Chemical Formula 2]) was crystalized by being cooled. The crystalized compound [Chemical Formula 2]) was gradually heated. As a result, it melted at the temperature of 11-12° C. The compound [Chemical Formula 2] was a liquid (under the conditions at 25° C. and 1 atmospheric pressure). In the distillation under reduced pressure performed by an oil rotation type vacuum pump, a boiling point thereof was 110° C.

The refined product had a high purity. The analysis values (unit: wt. ppm) obtained by the Inductively Coupled Plasma Mass Spectrometry (ICP-MS) were as set forth below. Na<0.1, Mg<0.1, Fe=0.4, Zn=0.3, Ti<0.1, Cu=0.1, Cd<0.1, Mn<0.1, Ni=1.1, and Pb<0.1.

The film deposition apparatus of FIG. 1 was used to perform a film deposition operation in a similar way as that of Example 1. The refined product (the compound [Chemical Formula 2]) was placed in the raw material container 1. The heater attached to the raw material container 1 heated the raw material container 1 to 90° C. A nitrogen gas (carrier gas) was supplied thereto at a rate of 20 ml/min. for bubbling. As a result, the compound [Chemical Formula 2] was introduced into the film deposition chamber 3 together with the nitrogen gas. A predetermined amount of additive gas (Ar gas of 40 scorn, NH₃ gas of 20 scorn, and H₂ gas of 80 sccm) 10 was supplied to the film deposition chamber 3. The wall of the film deposition chamber 3, the shower head 6, and the pipe connecting from the raw material container 1 to the shower head 6 are heated. The pump exhausted to vacuum the inside of the film deposition chamber 3. The pressure control valve provided between the film deposition chamber 3 and the pump controls the inside of the film deposition chamber 3 to a desired pressure (e.g., 1 kPa). The substrate 4 is heated. A film (metal thin film containing Co) was deposited on the substrate 4.

Thus deposited film had an excellent in-plane uniformity. The film was checked by the XPS. An amount of C in the film was 4 at % or less. An amount of 0 in the film was 1 at % or less. An amount of N in the film was 0.4 at % or less. The resistivity of the film was 20 μΩcm.

A comparison result between the compound of Example 2 and the compound of Example 1 follows below. In comparison with the boiling point (102° C./ in the distillation under the reduced pressure performed by an oil rotation type vacuum pump) of the compound of Example 1, the compound of Example 2 has a higher boiling point (110° C./ in the distillation under reduced pressure performed by an oil rotation type vacuum pump). Under the condition of the same temperature, compared with the vapor pressure of the compound of Example 1, the vapor pressure of the compound of Example 2 is lower. This means that the compound of Example 1 is preferred for depositing a film. Compared with the yield (89%) upon synthesizing of the compound of Example 1, the yield (70%) upon synthesizing of the compound of Example 2 is lower. The reagent “isopropyl lithium” that is used in synthesizing of the compound of Example 2 is expensive. This means that the compound of Example 1 can be obtained at lower cost. The compound of Example 1 is preferred also in view of the cost.

### EXAMPLE 3

{Fe[i-C₃H₇NC(n-C₃H₇)N-i-C₃H₇]₂: the Compound [Chemical Formula 3]}

The reaction was performed under an inert gas atmosphere. N, N′-diisopropylcarbodiimide of 0.22 mol was slowly dropped into a diethyl ether solution of 210 ml, the solution containing normal propyllithium of 0.21 mol, followed by stirring thereof at room temperature for 4 hours. The mixed reaction liquid was gradually dropped into a solution in which iron chloride (FeCl₂) of 0.1 mol was suspended in tetrahydrofuran of 80 ml, followed by stirring thereof for 24 hours. After distillation of the solvent, normal hexane of 400 ml was added thereto. Insoluble maters ware filtered. After distillation of the solvent, distillation under reduced pressure (0.1 torr) was performed. The compound [Chemical Formula 3] could be obtained by yield of 91%.

Thus obtained compound [Chemical Formula 3] of 300 g was subjected to distillation under reduced pressure for purification. The vaporized compound [Chemical Formula 3] (vapor) was liquified while passing through an air cooled tube to be collected in a receiving container. At the time, the air cooled tube was left at room temperature without being subjected to any cooling or heating operation. The compound could be obtained by yield of 97%.

The refined product (the compound [Chemical Formula 3]) was crystalized by being cooled. The crystalized compound [Chemical Formula 3] was gradually heated. The compound melted at the temperature of 12° C. The compound [Chemical Formula 3] was a liquid (under the conditions at 25° C. and 1 atmospheric pressure). In the distillation under reduced pressure performed by an oil rotation type vacuum pump, a boiling point thereof was 99° C.

The refined product had a high purity. The analysis values (unit: wt. ppm) obtained by the Inductively Coupled Plasma Mass Spectrometry (ICPMS) were as follows. Na<0.1, Mg<0.1, Zn=0.3, Ti<0.1, Cu=0.1, Co=0.4, Cd<0.1, Mn<0.1, Ni=1.1, and Pb<0.1.

By using the apparatus of FIG. 1, a film deposition operation was performed. The refined product (the compound [Chemical Formula 3]) was placed in the raw material container 1. The heater attached to the raw material container 1 heated the raw material container 1 to 90° C. A nitrogen gas (carrier gas) was supplied at a rate of 20 ml/min. for bubbling. As a result, the compound [Chemical Formula 3] was introduced into the film deposition chamber 3 together with the nitrogen gas. A predetermined amount of additive gas (Ar gas of 40 sccm, NH₃ gas of 20 sccm, H₂ gas of 80 sccm) was supplied to the film deposition chamber 3. The wall of the film deposition chamber 3, the shower head 6, and the pipe connecting from the raw material container 1 to the shower head 6 are heated (100° C.). A pump exhausted to vacuum the inside of the film deposition chamber 3. A pressure control valve controls the inside of the film deposition chamber 3 to a desired pressure (e.g., 1 kPa). The substrate 4 is heated (280° C.) by the substrate heater 2. A film (metal thin film containing Fe) was deposited on the substrate 4 in 10 minutes.

Thus deposited film had an excellent in-plane uniformity. The film was checked by the XPS. An amount of C in the film was 2 at % or less. An amount of 0 in the film was 1 at % or less. An amount of N in the film was 0.4 at % or less.

The apparatus of FIG. 1 was used to perform a film deposition operation. The refined product (the compound [Chemical Formula 3]) was placed in the raw material container 1. The heater attached to the raw material container 1 heated the raw material container 1 to 90° C. A nitrogen gas (carrier gas) was supplied at a rate of 20 ml/min. for babbling. As a result, the compound [Chemical Formula 3] was introduced into the film deposition chamber 3 together with the nitrogen gas for 5 seconds. A pump exhausted the inside of the film deposition chamber 3 for 12 seconds. A predetermined amount of additive gas (Ar gas of 40 sccm, NH₃ gas of 20 sccm, and H₂ gas of 80 sccm) was supplied to the film deposition chamber 3 for 5 seconds. The pump exhausted the inside of the film deposition chamber 3 for 12 seconds. Again, the compound [Chemical Formula 3] was introduced into the film deposition chamber 3 together with the nitrogen gas for 5 seconds. This process was repeated 50 times. The wall of the film deposition chamber 3, the shower head 6, and the pipe connecting from the raw material container 1 to the shower head 6 are heated (100° C.). The substrate heater 2 heated (150-200° C.) the substrate 4. A film (metal thin film containing Fe) was deposited on the substrate 4.

Thus deposited film was uniformly provided on the inner wall of a hole (opening portion having a width of 50 nm and a depth of 1 μm). The film was excellent in a step covering property. The film was checked by the XPS. An amount of C in the film was 2 at % or less. An amount of 0 in the film was 1 at % or less. An amount of N in the film was 0.2 at % or less.

The film deposition apparatus of FIG. 2 was used to perform a film deposition operation. The refined product (the compound [Chemical Formula 3]) was placed in the raw material container 1. As a raw material force feeding gas 9, an N₂ gas was used. The pressure controller 11 controls the pressure to 0.1 MPa. The liquid flow controller 12 force fed (An amount of force feeding was controlled to 0.1 mg/min.) the compound [Chemical Formula 3]. The compound [Chemical Formula 3] was transported into the vaporizer 8. The pipe through which the compound [Chemical Formula 3] passes is left at room temperature. The compound [Chemical Formula 3] transported into the vaporizer 8 was introduced into the film deposition chamber 3 together with an Ar gas (carrier gas) of 50 sccm. A predetermined amount of additive gas (Ar gas of 40 sccm, NH₃ gas of 20 sccm, and H₂ gas of 80 sccm) 10 was supplied to the film deposition chamber 3. The wall of the film deposition chamber 3, the shower head 6, and the pipe connecting from the raw material container 1 to the shower head 6 are heated (100° C.). The pump exhausted to vacuum the inside of the film deposition chamber 3. The pressure control valve controls to a desired pressure (e.g., 1 kPa). The substrate 4 is heated (290° C.) by the substrate heater 2. A film (metal thin film containing Fe) was deposited on the substrate 4.

Thus deposited film had an excellent in-plane uniformity. The film was checked by the XPS. An amount of C in the film was 4 at% or less. An amount of 0 in the film was 1 at % or less. An amount of N in the film was 0.3 at % or less.

### REFERENCE EXAMPLE 1

### (JP 2006-511716A1 (WO 2004/046417A1))

JP 2006-511716A1 discloses a compound that is represented by the following chemical formula.

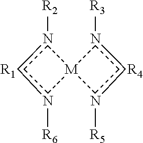

Where R₁, R₂, R₃, R₄, R₅, R₆ denote a hydrogen, an alkyl group, an aryl group, an alkenyl group, an alkynyl group, a trialkylcyril group, or a fluoroalkyl group, or another nonmetal atoms or groups. M is a metallic element selected from the group consisting of Co, Fe, Ni, Mn, Ru, Zn, Ti, V, Cr, Eu, Mg, and Ca.

JP 2006-511716A1 (WO 2004/046417A1) includes the following compounds as specific examples.

Cobalt bis (N, N′-diisopropylacetamidinate) ([Co(iPr-AMD)₂]): In the above Chemical Formula, M=Co, R₁═R₄═CH₃, R₂═R₃═R₅═R₆=i-Pr: solid body (having a melting point of 72° C.). The compound sublimes at 40° C. (50 mTorr).

Cobalt bis (N, N′-ditbutylacetamidinate) ([Co(iBu-AMD)₂]): In the above

Chemical Formula, M=Co, R₁═R₄═CH₃, R₂═R₃═R₅═R₆=i-Bu: solid body (having a melting point of 90° C.). The compound sublimes at 45° C. (50 mTorr).

Cobalt bis (N, N′-di-sec-butylacetamidinate) ([Co(sec-Bu-AMD)₂]): In the above Chemical Formula, M=Co, R₁═R₄═CH₃, R₂═R₃═R₅═R₆=sec-Bu: having a boiling point of 55° C. (60 mTorr). Here, there is no specific description whether the compound is a liquid or a solid in JP 2006-511716A1. In other words, JP 2006-511716A1 includes the following description: “The reaction mixture was subjected to stirring overnight and, then, volatile matters were removed at room temperature in vacuo. The solid was subjected to dissolution in dried hexane for filtration, followed by removal of hexane from the filtrate at room temperature in vacuo. As a result, cobalt bis (N, N′-di-t-butylacetamidinate) could be obtained by rough yield of 82%. The liquid was subjected to distillation (at 55° C. under 60 mTorr) for purification.” A hexane insoluble matter (here, lithium chloride) was filtered to remove from the reaction mixture. Then, the hexane was concentrated and removed therefrom. The resulting compound is not a pure product but a rough product. Even if the targeted product is a solid, it can be fully expected that the compound is represented by a liquid at the time (i.e., in the state of containing impurities (state of mixture)). Whether the targeted product is obtained in the state of liquid or solid can be known only after purification. In the case of the same temperature, the compound of the present invention has the vapor pressure lower than that of the compound (bis (N-tertiarybutyl-N′-ethylpropionamidinate) cobalt) of Reference Example 2 (JP 2011-63848A1). In the case of the same pressure reduction degree, the cobalt bis (N, N′-disecbutylacetamidinate) has a boiling point higher by 15° C. than that of the bis (N-tertiarybutyl-N′-ethyl propionamidinate) cobalt.

The cobalt bis (N, N′-disecbutylacetamidinate) cannot be separated with the current technique. Isolation thereof is impossible. A secondary butyl group has an asymmetric carbon. There exists a S body and a R body. In the compound, as described below, there exists 7 types of isomers. Crystallization hardly occurs in the mixture of 7 types of isomers.

S: S configuration

R: R configuration

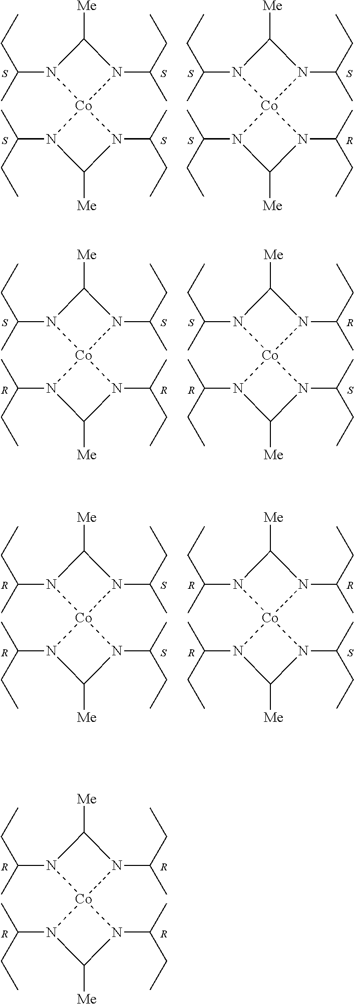

Iron bis (N, N′-di-t-butylacetamidinate) ([Fe(tBu-AMD)₂]): In the above Chemical Formula, M=Fe, R₁═R₄═CH₃, R₂═R₃═R₅═R₆=i-Bu: solid body (having a melting point of 107° C.). The compound sublimes at 55° C. (60 mTorr).

Iron bis (N, N′-diisopropylacetamidinate) ([Fe(iPr-AMD)₂]₂): solid body (having a melting point of 110° C.). The compound sublimes at 70° C. (50 mTorr).

Copper (N, N′-diisopropylacetamidinate) ([Cu(iPr-AMD)]₂): solid body. The compound sublimes at 70° C. (50 mTorr).

Lanthanum tris (N, N′-diisopropylacetamidinate) ([La(iPr-AMD)₃]): solid body. The compound sublimes at 80° C. (40 mTorr).

Lanthanum tris (N, N′-diisopropyl-2-t-butylamidinate) ([La(iPr-iBuAMD)₃]: solid body (having a melting point of 140° C.). The compound sublimes at 120° C. (50 mTorr).

Nickel bis (N, N′-diisopropylacetamidinate) ([Ni(iPr-AMD)₂]): solid body (having a melting point of 55° C.). The compound sublimes at 35° C. (70 mTorr).

Manganese bis (N, N′-diisopropylacetamidinate) ([Mn(iPr-AMD)₂]₂): solid body. The compound sublimes at 65° C. (50 mTorr).

Manganese bis (N, N′-di-t-butylacetamidinate) ([Mn(iBu-AMD)₂]₂): solid body (having a melting point of 100° C.). The compound sublimes at 55° C. (60 mTorr).

Titanium tris (N, N′-diisopropylacetamidinate) ([Ti(iPr-AMD)₃]): solid body. The compound sublimes at 70° C. (50 mTorr).

Vanadium tris (N, N′-diisopropylacetamidinate) ([V(iPrAMD)₃]): solid body. The compound sublimes at 70° C. (45 mTorr).

Silver (N, N′-di-isopropylacetamidinate) ([Ag(iPr-AMD)]ₓ (1:1 mixture of x=2 and x=3)): solid body (having a melting point of 95° C.). The compound sublimes at 80° C. (40 mTorr).

Magnesium bis (N, N′-di-t-butylacetamidinate) ([Mg(iBu-AMD)₂]):

Lithium N, N′-di-sec-butylacetamidinate:

Copper (I) N, N′-di-sec-butylacetamidinate dimer ([sec-Bu-AMD)]₂): solid body (having a melting point of 77° C.). The compound sublimes at 55° C. (50 mTorr).

Bismuth tris (N, N′-di-t-butylacetamidinate) dimer ([Bi(iBu-AMD)₃]₂): solid body (having a melting point of 95° C.). The compound sublimes at 70° C. (80 mTorr).

Strontium bis (N, N′-di-t-butylacetamidinate) ([St(iBu-AMD)₂]ₙ: solid body. The compound sublimes at 130° C. (90 mTorr).

Ruthenium tris (N, N′-diisopropylacetamidinate) ([Ru(iPr-AMD)₃]):

### REFERENCE EXAMPLE 2

### JP 2011-63848A1

JP 2011-63848A1 discloses the following compound.

Bis (N-tertiarybutyl-N′-ethyl-propionamidinate) cobalt (II) (Co(tBu-Et-Et-AMD)₂).

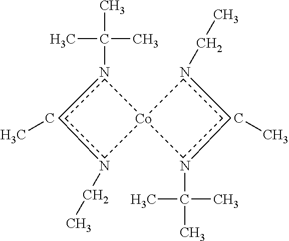

The compound is a liquid (under 25° C. (1 atmospheric pressure)).

The compound represented by the above Chemical Formula is a mixture of isomers (see below). At present, the compound cannot be separated (isolated), or purified. Even if only one isomer would be taken out, the amidinate complex of cobalt exchanges ligand, resulting in recovering to the original mixture. Because it is the mixture, it looks like liquid due to the mol melting point depression.

The compound was a liquid but had a high viscosity. This made it difficult to deposit a film by the method of the above described Examples.

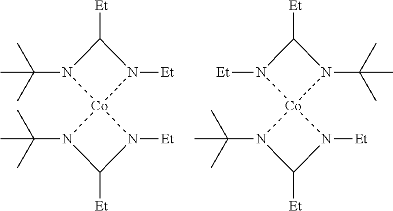

Where the vapor pressure of the compound of Example 1 is 0.53 Torr (100° C.), the vapor pressure of bis (N-tertiarybutyl-N′-ethyl-propionamidinate) cobalt is 0.31 Torr (100° C.). That is, the compound has a low vapor pressure. This is a serious defect in depositing a film.

Reference Example 1 (JP 2006-511716A1) includes the following description.

“Comparative Example 2. Example 18 (In this example, a compound was cobalt bis (N, N′-diisopropylacet)amidinate) was repeated by using only a cobalt precursor and by not using hydrogen. As a result, no deposition of a thin film was observed on the surface of the substrate.”

In a case where bis (N-tertiarybutyl-N′-ethylpropionamidinate) cobalt was used and where only hydrogen was used, similar to the case of Comparative Example 2 of JP 2006-511716A1, little metallic cobalt deposited. Here, in a case where hydrogen and ammonia were used together, metallic cobalt deposited. In a case where only ammonia was used, there was a contamination of cobalt nitride. In a case where the compound [Chemical Formula 1] was used, owing to the together use of hydrogen and ammonia, metallic cobalt having a high purity deposited. Even in a case where only ammonia was used, metallic cobalt having a high purity deposited. This means, when bis (N tertiarybutyl-N′-ethyl-propionamidinate) cobalt is used, there is a little freedom in depositing a film. More specifically, use of the compound [Chemical Formula 1] is more preferred.

Bis (N, N′-ditertiarybutyl-acetamidinate) nickel (II) (Ni(tBu-AMD)₂): solid body (having a melting point of 87° C.).

### REFERENCE EXAMPLE 3

### WO 2013/051670A1

WO 2013/051670A1 discloses a compound as represented by the following Chemical Formula.

Cobalt bis (N, N′-diisopropylpropionamidinate) (Co[i-C₃H₇NC(C₂H₅)N-i-C₃H₇]₂): In the above Chemical Formula, M=Co, R₁═R₄═C₂H₅, R₂═R₃═R₅═R₆=i-Pr: solid body (having a melting point of 38° C.).

### REFERENCE EXAMPLE 4

### JP 2016-172894A1

JP 2016-172894A1 discloses compounds as represented by the following Chemical Formulas.

[R¹—N—C(R²)=N—R³]₂Fe

[[R¹—N—C(R²)=N—R³]₂Fe]₂

(R² is a 2-6C alkyl group. R¹ and R³ are a 3-6C alkyl group. R¹ and R³ may be the same in its entirety or may be different from each other.)

N, N′-diisopropylpropionamidinate) iron (Fe[iso-C₃H₇,NC(C₂H₅)N-iso-C₃F1₇]₂): solid body (having a melting point of 33° C.)

### COMPARATIVE EXAMPLE 1

The apparatus of FIG. 1 was used to perform a film deposition operation. The compound of Reference Example 2 (Co(tBu-Et-Et-AMD)₂ was placed in the raw material container 1. The heater attached to the raw material container 1 heated the raw material container 1 to 90° C. A nitrogen gas (carrier gas) was supplied at a rate of 20 ml/min. for bubbling. As a result, the Co(tBu Et-Et-AMD)₂ was introduced into the film deposition chamber 3 together with the nitrogen gas for 5 seconds. A pump exhausted the inside of the film deposition chamber 3 for 12 seconds. A predetermined amount of additive gas (Ar gas of 40 scorn, NH₃ gas of 20 sccm, and H₂ gas of 80 sccm) 10 was supplied to the film deposition chamber 3 for 5 seconds. The pump exhausted the inside of the film deposition chamber 3 for 12 seconds. Again, the Co(tBu Et-Et-AMD)₂ was introduced into the film deposition chamber 3 together with the nitrogen gas for 5 seconds. This process was repeated for 100 times. The wall of the film deposition chamber 3, the shower head 6, the pipe connecting from the raw material container 1 to the shower head 6 are heated (100° C.). The substrate heater 2 heated the substrate 4 (150-200° C.). A film (metallic thin film containing Co) was deposited on the substrate 4.

In thus deposited film had the resistivity of 60 μΩcm in its flat section.

### COMPARATIVE EXAMPLE 2

The compound of Reference Example 1 ([Co(sec-Bu-AMD)₂]) was used to perform a deposition operation in accordance with the operation of Comparative Example 1.

In thus deposited film had the resistivity of 75 μΩcm in its flat section.

### REFERENCE NUMERALS

1 raw material container

2 substrate heater

3 film deposition chamber

4 substrate

5 flow controller

6 shower head

7 carrier gas

8 vaporizer

9 raw material force feeding gas

10 additive gas for film deposition

11 raw material force feeding gas-pressure controller

12 liquid rate flow controller

What is claimed is:

1. A novel compound:
wherein the compound is a liquid under the temperature of 25° C. (at 1 atmospheric pressure); and
wherein the compound is represented by M[i-C₃H₇NC(R)N-i-C₃H₇]₂ (where M=Co or Fe; R=n-C₃H₇ or i-C₃H₇).

2. The novel compound according to claim 1, wherein the R is n-C₃H₇.

3. The novel compound according to claim 1, wherein the compound is used for a method in which the compound is transported to a chamber and the compound transported to the chamber is decomposed to deposit a M based material on a substrate.

4. The novel compound according to claim 1, wherein the compound has no structural isomer.

5. The novel compound according to claim 1, wherein the compound has no optical isomer.

6. The novel compound according to claim 1, wherein the vapor pressure (100° C.) is 0.35 Torr or more.
